(19) United States
(12) Patent Application Publication
(10) Pub. No.: US 2006/0107847 A1
(43) Pub. Date: May 25, 2006

(54) Retractable small appliance caddy

(76) Inventor: Waldemar F. Kissel JR., Gainesville, FL (US)

Correspondence Address: Michael J. Colitz, III, Suite 4100, 100 N. Tampa Street, Tampa, FL, 33602, US

(21) Appl. No.: 11/283,059

(22) Filed: Nov. 18, 2005

Related U.S. Application Data
(60) Provisional application No. 60/630,190, filed on Nov. 19, 2004.

(51) Int. Cl. A23G 9/04

(52) U.S. Cl. 99/484

(57) ABSTRACT

Disclosed is a caddy for use in storing kitchen appliances. The caddy includes a retractable cabinet comprising a number of individual storage units. The caddy can be extended from an out-of-the-way location via a hydraulic ram. Each of the individual storage units in the caddy includes its own outlet and power switch that are electrically connected to a main power supply. Thus, the caddy allows for the convenient storage and use of a large number of appliances.

### RELATED APPLICATION DATA

This application claims priority from and is related to commonly owned U.S. Provisional Patent Application Ser. No. 60/630,190 filed on Nov. 19, 2004 and entitled Retractable Small Appliance Caddy, the contents of this application are fully incorporated herein.

### BACKGROUND OF THE INVENTION

1. Field of the Invention

This invention relates to an appliance caddy for use within a kitchen. More particularly, the present invention relates to a caddy that can store a number of different small appliances within a retractable cabinet and which provides an outlet for each of the stored appliances.

2. Description of the Background Art

Small appliances are available to consumers in ever increasing numbers. These appliances are designed to simplify both food preparation and cooking. For instance, many consumers today have one or more of the following appliances: coffee grinder, mixer, food processor, spice grinder, toaster oven, electric knife, meat thermometer, quiche maker, George Foreman® grill, waffle maker, bread machine, meat slicer, ice cream maker, and/or meat grinder. Unfortunately, the proliferation of these appliances has surpassed the size of most kitchens.

As a result, these appliances are not stored in an easily accessible place, such as on a countertop, but at the back of a cabinet, closet or some other difficult to access location. This results in appliances that are not used as frequently as they should. Moreover, on the rare occasion when the appliance is brought out, it must compete for scarce outlets in the kitchen. This presents yet another obstacle to the use of the appliance. The present invention is designed to overcome these deficiencies.

The background art contains some examples of retractable surfaces for use within a kitchen. For instance, U.S. Pat. No. 2,456,429 to Parsons discloses an actuating mechanism for refrigerators. The mechanism is for use with the shelving associated with a refrigerator. The mechanism allows the shelving to be raised or lowered via a fluid activated motor. Likewise, U.S. Pat. No. 6,213,575 to Brin, Jr. et al. discloses a kitchen countertop assembly with multiple vertically adjustable integrated work spaces. In one embodiment, a number of the work surfaces are defined by an overall kitchen island.

Although each of the above referenced devices achieves its own individual objective, none of the referenced inventions contemplate the storage of kitchen appliances in retractable shelving units.

### SUMMARY OF THE INVENTION

It is therefore one of the objectives of this invention to provide a retractable small appliance caddy that allows a large number of individual appliances to be conveniently stored and readily accessed.

It is also an object of this invention to provide a retractable appliance caddy that provides individual outlets for a number of different appliances.

Still another object of this invention is to provide an appliance caddy that retracts to a stored out-of-the-way location thereby preserving a user's countertop space.

Still another object of this invention is to provide an out-of-the-way, relatively accessible storage location thereby reducing the cluttered look and preserving a user's counter top space. The caddy can also increase the usable volume of cabinet space without requiring a proportionate increase in the area of the kitchen.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a side elevational view of an island within a kitchen employing the caddy of the present invention.

FIG. 2 is an illustration of the caddy of the present invention in its extended orientation.

FIG. 3 is a partial sectional view of the caddy taken along line 3-3 of FIG. 2.

FIG. 3A is a partial sectional view of an alternative caddy wherein the caddy is lifted from the center of the caddy but wherein the boom does not extend to the top of the caddy.

FIG. 3B is a partial sectional view of another alternative caddy wherein the caddy is lifted from the side of the caddy.

FIG. 4 is a plan view of the island taken along line 4-4 of FIG. 3.

FIG. 5 is a plan view showing various implementations of the caddy of the present invention.

FIG. 6 is a side elevational view showing the caddy disposed behind a countertop and behind a wall-mounted cabinet.

FIG. 7 is a front elevational view of another arrangement for the caddy of the present invention.

FIG. 8 is a side elevational view of another arrangement for the caddy of the present invention.

Similar reference characters refer to similar parts throughout the several views of the drawings.

### DETAILED DESCRIPTION OF THE PREFERRED EMBODIMENT

The present invention relates to a caddy for use in storing kitchen appliances. The caddy includes a retractable cabinet comprising a number of individual storage units. The caddy can be extended from an out-of-the-way location via a hydraulic ram. Each of the individual storage units in the caddy includes its own outlet and power switch, all of which are electrically connected to a main power supply. Thus, the caddy allows for the convenient storage and use of a large number of appliances in a manner described more fully hereinafter.

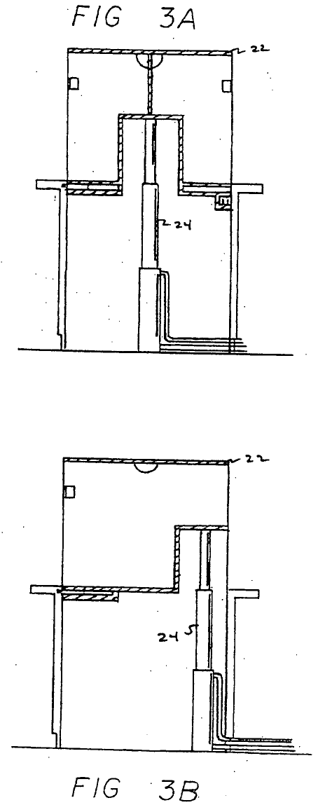

FIGS. 1-4 illustrate the primary embodiment 20 of the present invention; namely, the use of the caddy 22 within a floor mounted cabinet, such as the island of a kitchen. Specifically, island includes a centrally-located caddy 22 that is dimensioned to fit within an internal space of the island. The caddy 22 can be extended or retracted by way of a hydraulically powered telescopic boom 24 (note FIG. 3). As will be appreciated by those skilled in the art, boom 24 is employed in raising caddy 22 to an elevated position beyond the peripheral edge 48 of the island whereby a user can gain access to the individual storage units 26 of caddy 22. Alternatively, boom 24 can be used to lower caddy 22 (note FIG. 1) to an out-of-the-way location. The island itself has an opened top, such that when caddy 22 is fully retracted the upper surface 28 of caddy 22 acts as the top surface of the island.

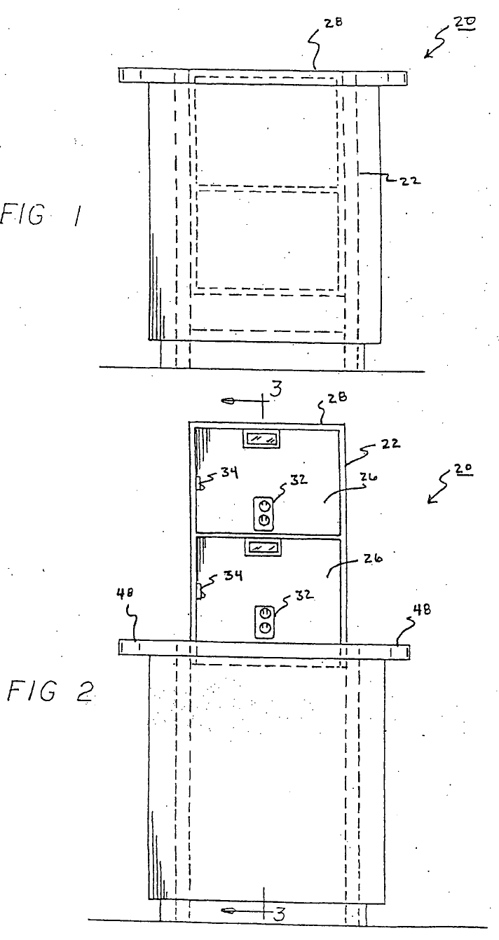

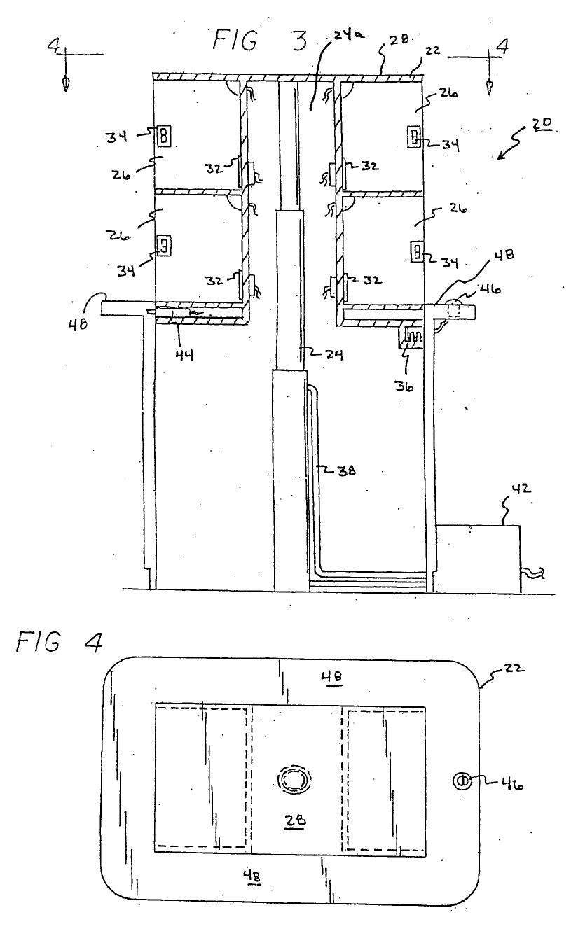

FIG. 3 is a cross-sectional view illustrating the individual storage units 26 on either side of caddy 22; FIG. 2 is an end view showing the individual storage units 26 at the end of caddy 22. The caddy 22 can be configured to include any number of individual storage units 26. However, in the embodiment illustrated in FIGS. 2 and 3, eight individual storage units 26 are included: two at either end and two on either side. Ideally, each of these individual units 26 is deep enough and tall enough to house common everyday appliances such as a toaster oven or food processor. The caddy 22 can, of course, be configured with larger storage units to allow for the storage of larger appliances. FIG. 3 also illustrates the channel 24a that is formed within caddy 22 by adjacent storage units 26. The channel accommodates telescopic boom 24. As noted in FIG. 3, telescopic boom 24 is mounted between the floor and the upper surface of the caddy.

With continuing reference to FIGS. 2 and 3, the outlets and switches (32 and 34 respectively) present within the individual units are depicted. That is, each individual 26 unit has its own outlet 32 for supplying power to the appliance being stored therein. A switch 34 is also included for regulating the power to the outlet. Power to all of the units is delivered from a common, main household power supply with the wiring being routed from within the island. A master switch 36 can also be included, whereby power to caddy 22 is only permitted when it is in its fully extended orientation (note FIG. 3).

With continuing reference to FIG. 3, the hydraulic lines 38 used to power telescopic boom 24 are depicted. In the preferred embodiment, hydraulic fluid is employed to raise and lower telescopic boom 24. However, it is within the scope of the present invention to pneumatically power the boom. Thus, in the preferred embodiment, the invention includes a suitable housing for storing a supply of hydraulic fluid 42 and an associated pump (not shown) for selectively delivering hydraulic fluid to or removing hydraulic fluid from telescopic boom 24. A limit switch 44 is also included between the bottom of the caddy 22 and the top of island. This limit switch 44 serves to stop the flow of hydraulic fluid once caddy 22 is in its fully extended position (note FIG. 3) and locks the caddy into its extended position to prevent inadvertent retraction.

FIGS. 3A-3B illustrate alternative embodiments wherein the hydraulic cylinders are positioned centrally within the caddy (FIG. 3A) or offset to one side (FIG. 3B). These arrangements can be utilized to maximize the storage area within the caddy.

The operation of the invention is next described in conjunction with FIGS. 1-4. With caddy 22 installed, a user is free to use the entire upper surface 28 of caddy 22 in a conventional fashion (note FIG. 1). That is, with the caddy 22 and boom 24 in the fully retracted orientation, caddy 22 is fully enclosed within the internal space of the island. In this orientation, the upper surface 28 of caddy 22 and the peripheral edge 48 of the island form a continuous work surface (note FIG. 4). However, if the user subsequently wishes to use one of the stored appliances, they can manipulate an extension/retraction switch 46 (FIG. 4) to start the flow of hydraulic fluid to place boom 24 and caddy 22 in the extended orientation. Once caddy 22 is fully raised above the peripheral edge of the island, limit switch 44 is activated and the flow of hydraulic fluid is terminated. The user can then access one of the individual appliances stored within the caddy. Here, the extension of the caddy 22 triggers master switch 36 to power each of the outlets 32 within the individual units 26.

In the preferred embodiment, island 20 is large enough such that, even with caddy 22 extended, a sufficient amount of peripheral countertop space 48 remains. This peripheral space 48 can be used as a work surface for food preparation and/or utilizing the selected appliance. The outlets and power switches (32 and 34) within the individual storage units 26 alleviates the need of having to find an outlet for the appliance.

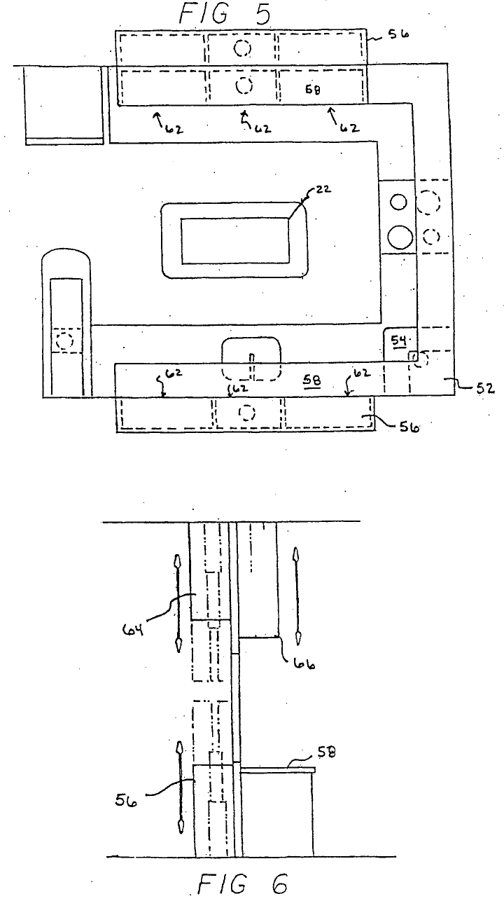

FIG. 5 is a plan view of a kitchen showing various locations where the caddy of the present invention can be employed. As noted in FIGS. 1-4, the caddy 22 can be used in the central part of island. However, a similar caddy 52 can just as easily be employed within the back corner 54 of a kitchen countertop, which is often considered to be “dead space” within a kitchen. Still additional caddies 62 can be located behind countertops 58.

A detailed view of a behind the cabinet embodiment is depicted in FIG. 6. Here, caddy 56 is located behind a counter 58, which can include a kitchen sink, and can be selectively raised or lowered for access or storage by a user. In the retracted position, caddy 56 is completely hidden from view behind counter 58. This behind-the-counter embodiment does not include individual storage units on all sides as does the island embodiment of FIGS. 1-4. Rather, the behind-the-counter embodiment simply includes forwardly facing storage units that can be easily accessed by someone standing behind counter 58. FIG. 6 also show another caddy 64 can be used behind a wall-mounted cabinet 66. In this embodiment, caddy 64 can be extended downwardly so that a consumer can access forwardly facing storage units. Thereafter, the caddy 64 can be retracted upwardly to an out of sight location behind wall-mounted cabinet 66. The behind the counter and behind the cabinet embodiments depicted in FIG. 6 can be utilized individually or together. If used together, care should be taken to ensure proper clearance between the units in their fully extended orientations.

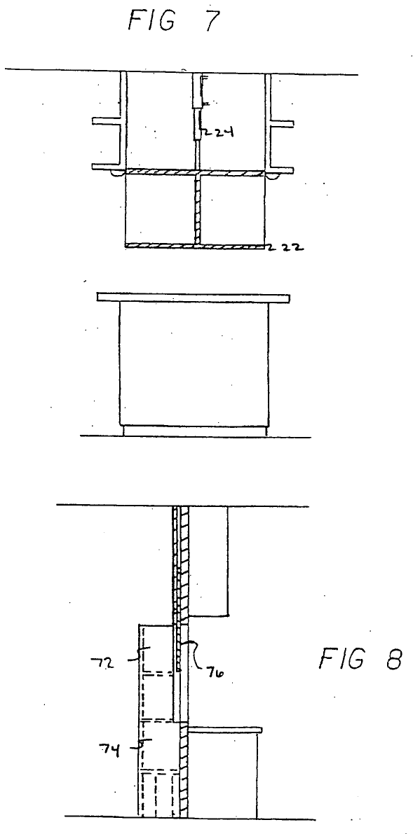

FIG. 7 illustrates yet another embodiment of the caddy wherein it extends downwardly from a ceiling to a convenient height above an island cabinet. This embodiment may include shelving, curios and/or lighting about the outside of the cabinet. This embodiment utilizes a ceiling mounted hydraulic powered telescopic boom 24 to extend or retract the caddy 22. As with the primary embodiment, this caddy can have storage units 62 located on its four sides to provide for maximum storage space. The boom configurations depicted in FIGS. 3A and 3B could also be employed with the ceiling mounted embodiment.

FIG. 8 illustrates another embodiment with the caddy installed behind a customary wall cabinet. The caddy is as tall as the bottom of the upper wall cabinet and includes upper and lower sections 72 and 74. An automatically retractable door 76 is also included that is activated to provide access to the interior of the caddy. A pair of hydraulic lifting cylinders is included to raise and lower the caddy and, thereby, selectively provide access to the upper and lower components of the caddy.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. Storage device for use within a kitchen comprising:
a cabinet mounted upon a floor and having an internal space and an opened top, a peripheral edge about the opened top, the peripheral edge constituting a work surface;
a caddy dimensioned to fit within the opened top of the cabinet, the caddy having a number of individual storage units about its periphery, a channel formed within the caddy, the channel being formed by adjacent storage units, each of the individual units housing a small kitchen appliance, the caddy having an upper surface;
power outlets and switches located within each of the individual storage units for use in powering the associated small kitchen appliance, a main power supply providing power to each of the power outlets;
a telescopic boom positioned within the internal space of the cabinet and the channel of the caddy, the telescopic boom being mounted between the floor and the upper surface of the caddy, the boom having an extended and a retracted orientation, wherein with the boom in the extended orientation, the caddy is positioned above the peripheral edge of the cabinet and with the boom in the retracted orientation the caddy is completely positioned within the internal space of the cabinet such that the upper surface of the caddy and the peripheral edge of the cabinet form a continuous surface;
a housing for a volume of hydraulic fluid and hydraulic lines for routing hydraulic fluid into and out of the telescopic boom for selectively positioning the boom in either the extended or retracted orientation.

2. Storage device for use within a kitchen comprising:
a cabinet having an internal space and a peripheral edge;
a caddy dimensioned to fit within the cabinet, the caddy having a number of individual storage units, a channel formed within the caddy, the channel being formed between adjacent storage units;
a telescopic boom positioned within the channel of the caddy, the boom having an extended and a retracted orientation, wherein with the boom in the extended orientation, the caddy is positioned beyond the peripheral edge of the cabinet and with the boom in the retracted orientation the caddy is completely positioned within the internal space of the cabinet.

3. The storage device as described in claim 2 further comprising a housing for a volume of hydraulic fluid and hydraulic lines for routing hydraulic fluid into and out of the telescopic boom for selectively positioning the boom in either the extended or retracted orientation.

4. The storage device as described in claim 2 wherein power outlets and switches are located within each of the individual storage units for use in powering an associated small kitchen appliance, a main power supply providing power to each of the power outlets.

5. The storage device as described in claim 2 wherein a small kitchen appliance is positioned within at least one of the individual storage units.

6. Storage device for use within a kitchen comprising:
a caddy having at least one individual storage unit;
a telescopic boom positioned within the caddy, the boom having an extended and a retracted orientation, wherein with the boom in the extended orientation, the storage unit of the caddy is accessible by a user and with the boom in the retracted orientation the storage unit of the caddy is inaccessible;
a power supply within the individual storage unit for use in powering an associated appliance;
an appliance positioned within the individual storage units.

7. The storage device as described in claim 6 wherein the boom is hydraulically powered.

8. The storage device as described in claim 6 wherein the caddy includes a plurality of forwardly facing storage units.

9. The storage device as described in claim 6 wherein the caddy includes a plurality of storage units about its periphery.

10. The storage device as described in claim 6 wherein the caddy is positioned within the island of a kitchen.
